(19) United States
(12) Patent Application Publication
(10) Pub. No.: US 2018/0330070 A1
(43) Pub. Date: Nov. 15, 2018

(54) SYSTEM AND METHOD FOR SMART WEAPON IMPLEMENTATION AND DEPLOYMENT

(71) Applicant: COVERQUICK, INC., Melville, NY (US)

(72) Inventor: Gregg Nicoll, Melville, NY (US)

(21) Appl. No.: 16/048,791

(22) Filed: Jul. 30, 2018

Related U.S. Application Data
(63) Continuation of application No. 15/983,875, filed on May 18, 2018.
Application No. 15/983,875 is a continuation of application No. 15/083,419, filed on Mar. 29, 2016, now abandoned.

(51) Int. Cl. G06F 21/32; F41A 17/06; H04W 4/80; F41A 17/08

(52) U.S. Cl. CPC G06F 21/32; F41A 17/066; F41A 17/063; F41A 17/08; H04W 4/80

(57) ABSTRACT

A weapon is equipped with processing capabilities and can include, inter alia, communication technology, geographic positioning systems, a camera, memory and the ability to enable or disable the weapon remotely. Through the application of various protocols (e.g., access, monitor, control, programming), a weapon can be designated for one or more authorized users, and will not operate when not being used by an authorized user. Other implementations include smart ammunition that can also be programmed for a specific user, or more preferably for a specific weapon, such that the weapon and/or the ammunition would not work without the other, and only by the registered authorized user of the same.

### BACKGROUND

### 1. Technical Field

The present principles relate to smart weapons. More particularly, it relates to smart weapons and systems for monitoring the deployment, use and capabilities of one or more weapons and/or ammunition within the one or more weapons.

### 2. Discussion of Related Art

The concept of a “smart” weapon is a new one. To date, the mechanisms that enable the control of a weapon (e.g., firearm) are generally external to the weapon. For example, a trigger lock or barrel-lock. These locking devices are often operated with a key, and in some instances, these devices have become “smarter” and use biometric devices, such as a finger print reader.

External storage devices for weapons or firearms (e.g., Safes) also use combinations and biometric sensing devices.

### SUMMARY

According to an implementation, the smart weapon includes a processor in communication with a memory and a communication system integrated into the weapon and being in communication with the processor. A personal ID system is integrated into the weapon and is also in communication with the processor. The personal ID system is configured to identify an authorized user of the weapon. A mechanical or electronic disabling system is included in the weapon and is also in communication with the processor. The disabling system is configured to mechanically or electronically disable operation of the weapon when the personal ID system determines that the authorized user is not using the same.

According to another implementation, the weapon includes a processor in communication with a memory and a communication system integrated into the weapon and in communication with the processor. A geographic positioning system (GPS) is integrated into the weapon and is in communication with the processor. A mechanical or electronic disabling system is included in the weapon and is also in communication with the processor. The disabling system is configured to mechanically or electronically disable operation of the weapon when it is determined that the weapon has traveled within or outside a predetermined geographic region.

According to a further implementation, an external network is in communication with the weapon via the weapon's communication system, and at least one computing device is in communication with the external network. The at least one computing device is configured to perform at least one of the following actions: authenticate authorized users of the weapon using the personal ID system; authenticate ammunition relating to an authenticated or authorized weapon; and remotely activate the disabling system when a user of the at least one computing device determines that the weapon should be rendered inoperative for any reason, whether authenticated or not.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a basic block diagram of an external locking device for a firearm;

FIG. 2 is a block diagram of the proposed smart weapon, according to an implementation of the present principles;

FIG. 3A is a schematic overview of a system for deployment and monitoring of one or more smart weapons according to an implementation of the present principles;

FIG. 3B is a schematic overview of a system for deployment and monitoring of one or more smart weapons according to another implementation of the present principles;

FIG. 4 is a block diagram of the smart weapon communication system/protocols according to an implementation of the present principles;

FIG. 5 is a block a diagram of the smart weapon communication system according to an implementation of the present principles;

FIG. 6 is more detailed schematic overview of a system for deployment and monitoring of multiple clustered and/or smart weapons according to an implementation of the present principles;

FIG. 7 is a schematic representation of ammunition to which the present principles can be applied;

FIG. 8A is a schematic representation of the ammunition of FIG. 7 showing the implementation of the present principles;

FIG. 8B is a schematic representation of an alternative implementation of the ammunition according to the present principles;

FIG. 9A is an illustration of a handgun according to another implementation of the present principles; and

FIG. 9B is a block diagram schematic representation of the handgun of FIG. 9A according to yet a further implementation of the present principles.

### DETAILED DESCRIPTION

The present principles are directed to smart weapons, and corresponding systems to control and monitor the same both in a small (civilian) and large (military) level.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

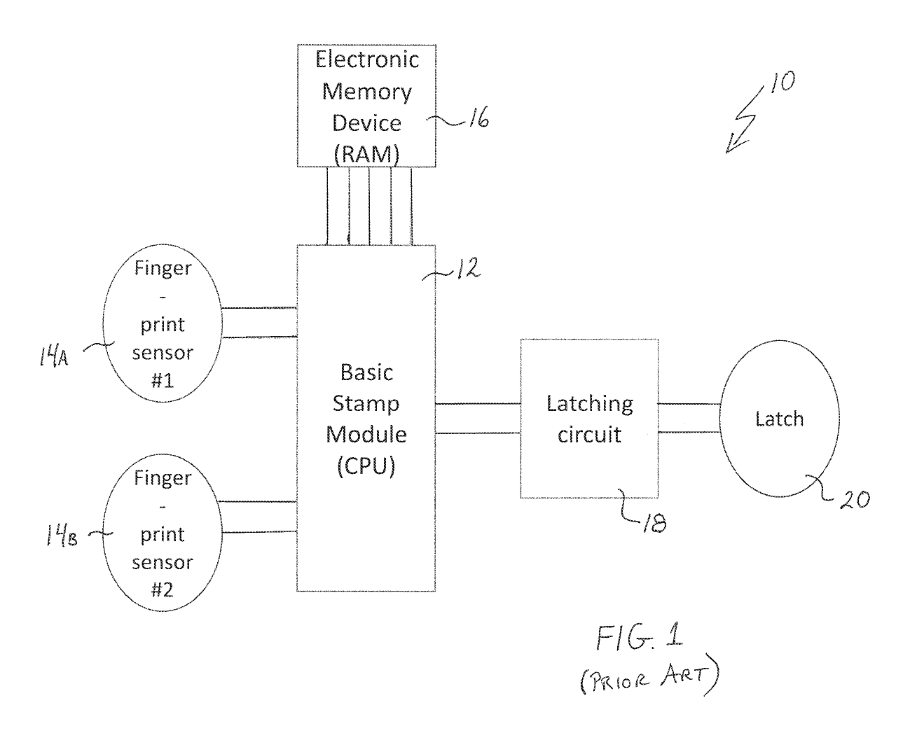

Referring to FIG. 1, there is shown a system 10 for a known external trigger lock. The trigger lock includes some basic processing capability via a processor 12, a memory such as RAM 16, a latching circuit 18 with corresponding latch 20. One or more finger print sensors 14 are in communication with the processor 12. During operation, the user first programs the system with their finger print via one of the finger print sensors 14 and some initial set up routine which would come stored on the memory 16 and/or processor 12 when purchased or previously programmed. Once setup, the user would then attach the external latch 20 of the lock system 10 to the trigger of a firearm (not shown) and lock the same. In order to release the latch 20, the user would apply their finger print to one of the sensors 14 and the processor would make the necessary comparison to determine if this user is authorized to release the latch. If authorized, the processor 12 sends a signal to the latching circuit 18 which then unlatches the latch 20, thus unlocking the trigger lock. The latch 20 can be any suitable structure having two operable positions, one where the weapon is active and one where it is inactive (e.g., mechanical, electro mechanical, electronic).

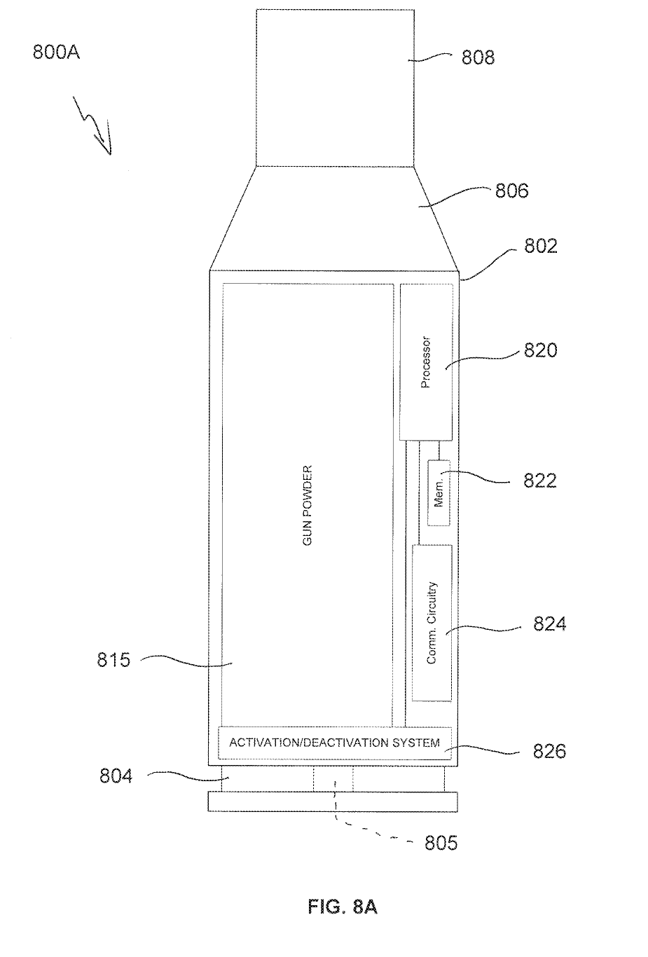

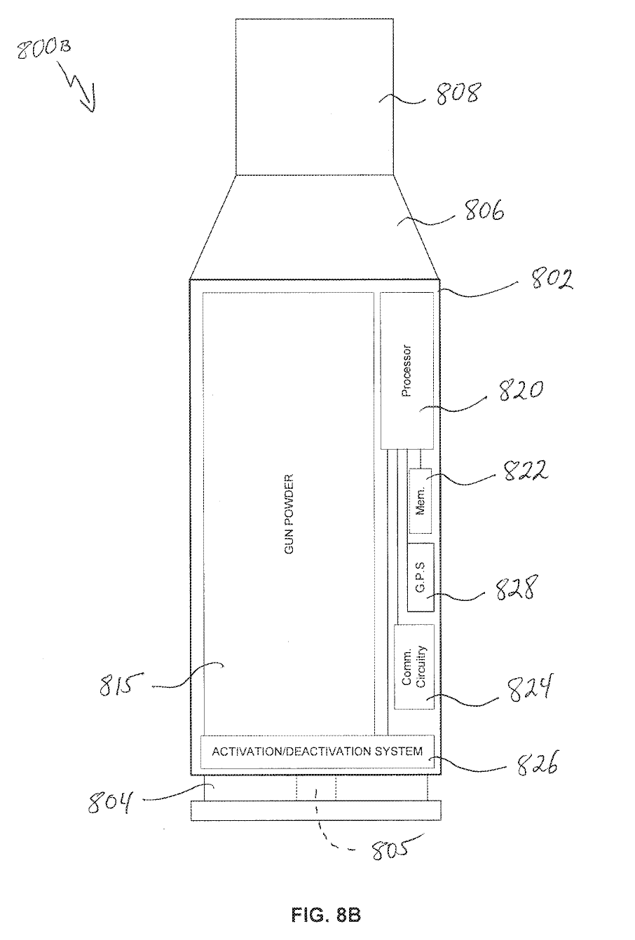

The present principles focus on the concepts of the “authorized user” or “group of authorized users” for one or more weapons or ammunition, and the implementation of a more complex system for identifying the “authorized” user or groups of users, to enable the activation and/or deactivation of such one or more weapons, remotely or by configuring the one or more weapons or ammunition (FIG. 8B) to work for only the authorized user or groups of authorized users. For purposes of clarification, the term “weapon” as used herein can mean any type of firearm (e.g., rifle, pistol, shotgun, stun gun, tazer), and is also intended to mean military weapons such as tanks, bombs, grenades, rocket launchers, and/or any other weapon that can be operated by a human being. For further clarification, a “weapon that can be operated by a human being” can include weapons that are remote in nature (e.g., drone or unmanned roving or flying machines capable of deploying or using weapons) and require a human being to man a console or other control center for such remote weapon or weapons. The term “ammunition” is intended to mean any type of bullet or other device that is or is capable of being fired by a weapon.

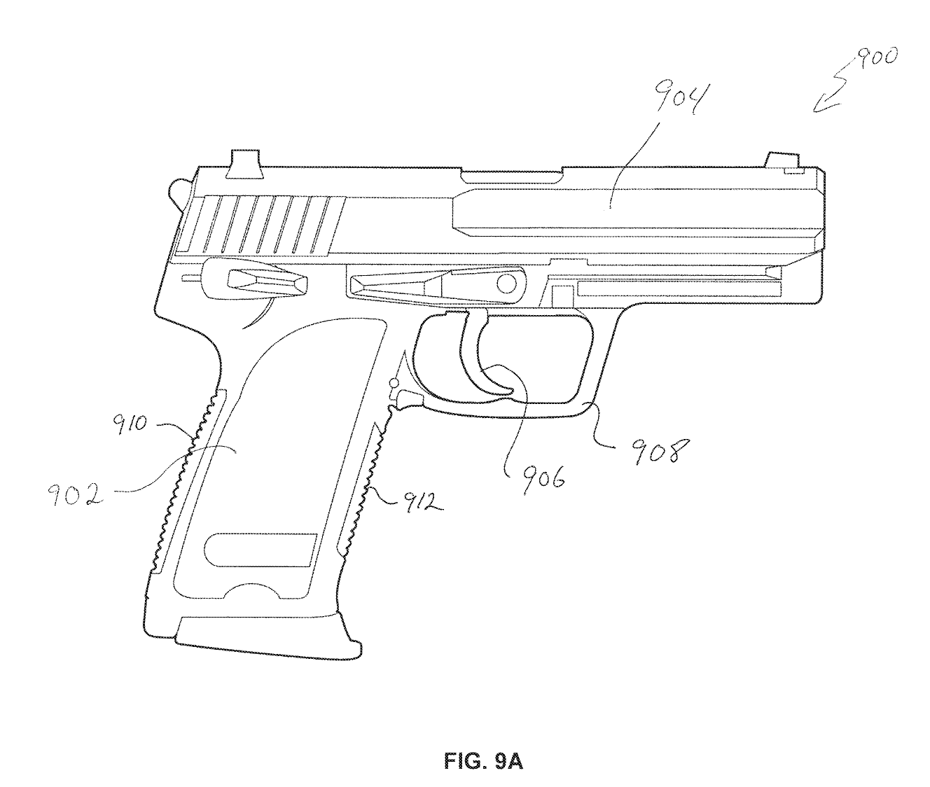

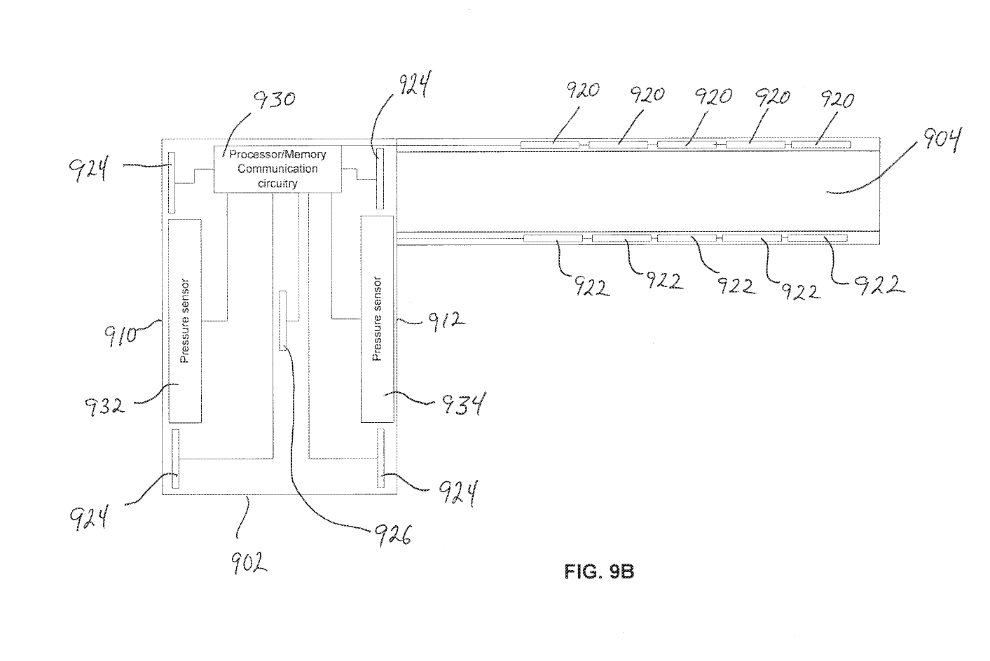

Before getting into the details of the various implementations, applicant provides a summary of the various capabilities contemplated herein. A primary capability is “access” to the weapon. “Access” as used herein is not intended to mean physical access, but rather the activation or enabling of the weapon for an authorized user, users, or group of users. By way of example, the weapon shall be in communication with the authorized user (in one way shape or form—to be described in more detail below), such that the weapon will only function when in the hands of an authorized user. This “access” can also include the ability to notify the authorized user (or for example a remote central station) when the weapon has found its way into the hands of an unauthorized user. Additionally, “Access” within the scope of this disclosure can also mean that the weapon or ammunition can be active, only when an “access” factor is present and cleared. For example, “access factors” can include that the weapon or ammunition must be within a certain predetermined distance from the authorized user (e.g., NFC authentication/communication capability), that the weapon and/or ammunition is within a predetermined authorized geographic area, that the user passed one or more of the personal identification mechanisms security protocols (e.g., retinal or facial scan, DNA, hand position—FIG. 9B), and that the weapon did not focus on (e.g. using the camera systems) and identify a prohibited object such as, for example, a child. It will be appreciated that these “access factors” can be established at the purchase or issuance of the weapon or ammunition, and can only be changed by the authorized user (after purchase), or in the case of “issued” weapons to the military or law enforcement, by a central or overseeing authority associated with the same. The camera could also enhance the targeting capabilities of the weapon, and may when using smart ammunition, include “lock-on” target functionality similar to how lasers are used in some advanced military planes and tanks.

In accordance with other implementations, another capability of the smart weapon and/or ammunition as disclosed herein can be referred to as “monitor factors”. The “monitor factors” include, for example, the ability to monitor, track and even report as to a weapon's activity (e.g., geographic location, who is the authorized user, and in some cases, self-destruction). Other “monitor factors” can include, for example: the ability to track the health of the weapon and/or ammunition; and/or the ability to record (via a camera system) video and/or still pictures relating to the weapon, both before and after firing the same. The pictures and/or video could be transmitted to a remote location for remote observation.

In accordance with other implementations, another capability of the smart weapon and/or ammunition as disclosed herein can be referred to as “control factors”. The “control factors” are those that allow the weapon and/or ammunition to be disabled when an “access factor” fails to meet the appropriate criteria, or to be activated when the access factor meets the appropriate criteria. Other control factors may include the ability to erase any weapon logs maintained by the weapon, deactivate the weapon and/or detonate the weapon (e.g., convert the weapon into a grenade type of device).

Other contemplated capabilities may include the ability to improve weapon functioning by including the camera technology into the same. Programming of the weapon can be done remotely or on site (e.g., at the weapon's location) using wired or wireless communication protocols. Reporting of the weapon's activities, almost in real time, along with providing analytics relating to such use would also be possible with the smart weapon and/or ammunition principles as disclosed herein. This could include, for example, who is using the weapon, what weapon they are using, where the weapon is being used, when the weapon is being used, and how and why the weapon was used.

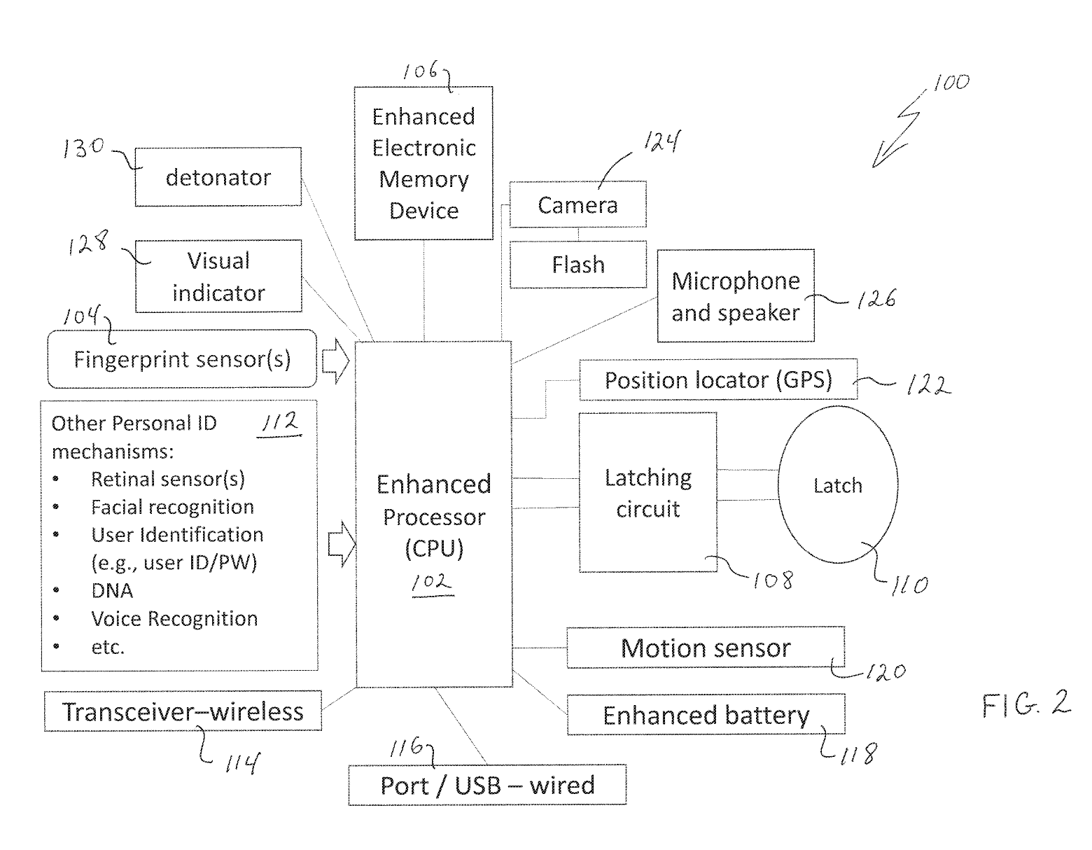

Initially, we start our discussion by referring to FIG. 2 and the enhanced smart weapon system 100 of the present principles. In this particular exemplary implementation, this system 100 is to be integrated into the weapon itself. In other contemplated implementations, the system of the present principles can be retrofitted to be external to the weapon itself. The system 100 includes a processor 102, and associated memory or memories 106 (e.g., ROM, RAM, EPROM), a latching circuit 108 and latch 110 which enable the use or deactivation of the weapon. Unlike the latching circuit 18 and latch 20 of the trigger lock of FIG. 1, the latching circuit 108 and latch 110 are integrated internally into the smart weapon and can either be a mechanical connect/disconnect within the weapon, an electro-mechanical connect/disconnect within the weapon, or could be an electronic connect/disconnect within the weapon, which would operate to connect or disconnect an electronic signal designed to enable or disable use of the respective weapon. Examples of the latching circuit can be, for example, a solenoid (for an electromechanical implementation), a logic circuit using a digital signal that either opens or closes a mechanical switch, an electronic relay that electronically opens or closes an electronic switch that is in direct communication with the weapon's manual trigger, etc. Any other suitable known method can also be implemented without departing from the intended scope of the present principles.

The weapon with system 100 implemented therein can include standard biometric fingerprinting sensors 104, but preferably include one or more of many other types of personal identification systems 112. Examples of such systems include, but are not limited to, retina readers, facial recognition, a User ID and password, DNA sampling, and/or voice recognition. The weapon system 100 shall also include a wireless transceiver 114, USB/network port 116, one or more forms of battery power 118, motion sensors 120, a position locater 122 (e.g., geographic positioning system), a camera 124 with or without a flash, a microphone and speaker 126 and a visual indicator 128 such as, one or more LEDs capable of providing a visual indication of the operation status or state of the weapon (e.g., green for enabled, red for disabled). The speaker can be used as an audible indicator of the operation mode of the weapon.

Although shown as one camera 124 in FIG. 2, alternative implementations can include multiple cameras (e.g., front and rear facing cameras or even 360 degree cameras) and can include additional features, such as night vision and/or the ability to use the camera system to “lock on” to a target, similar to the ability some missiles have to “lock on” to their target. This concept could work with smart bullets, or could simply be an aid to the targeting systems of the weapon by removing a bulky scope and replacing the same by a video camera scope system.

In one implementation, a detonator 130 can be also integrated into the smart weapon 100. The detonator 130 would not operate to explode the weapon, but rather would be configured so as to permanently disable the weapon from a remote location.

As will start to be appreciated by the above, by implementing one or more of these smarter technologies into a weapon, the ability to control the same on a much more global level will become apparent. Before getting into the larger scale implementations contemplated by the present principles, some smaller scale, and even personal scenarios of operation of the smart weapon disclosed herein are made.

In one scenario, a homeowner having a smart weapon within the context of this disclosure can control the use of that weapon on many different levels. The obvious control using a biometric fingerprint on the weapon itself will only allow that user to activate and use the weapon. The additional personal identification methods (e.g., retina or facial recognition, DNA sampling, voice recognition) or a combination of methods will significantly improve the security, and can be used to enhance existing personal identification concepts and methods of weapon activation by only the authorized users. These systems alone can and will prevent anyone other than the registered owner of the weapon from using the same, particularly when the registered owner is not present.

However, several other systems are contemplated which provide significantly enhanced control over a single ammunition or group of ammunitions (FIG. 8A, 8B), a single weapon or group of weapons (FIG. 2, 9B), and/or a single user or group of users. A sample list of such systems include, for example:

A. Geographic location (e.g., GPS, WiFi, or RF (Radio Frequency) or position location of the weapon;

B. Hand pressure and/or motion sensing of the weapon; C. Voice and/or facial recognition of the user.

As a more general overview, each ammunition or group of ammunitions will be authorized for a specific weapon or group of weapons (i.e., the ammunition would not be operational if fired from an unauthorized weapon) and/or a specific user or group of users, and each weapon or group of weapons will be authorized for a user or group of users (i.e., weapons could not be operated by unauthorized users). In addition, authorizations could be set independently for ammunition(s), weapon(s), and/or User(s).

For example, for a weapon to be usable within a “safe” zone, such as a school zone, the ammunition must be authorized/authenticated for that geographic area (e.g., GPS) as well as for the authorized/authenticated weapon, and additionally the weapon must be authorized/authenticated for that geographic area (e.g., GPS) as well as for the user, and the user must be authorized for the geographic area. Authorizations could include, for example, “who” is being authorized to use a weapon (e.g., a security guard), “what” weapon they are being authorized to use (e.g., a hand gun), “where” they are being authorized to use the weapon (e.g., school zone), “when” they are being authorized to use the weapon (e.g., non-school days and times), “how” they are authorized for use the weapon (e.g., while in hand), and for “why” they are being authorized to use the weapon (e.g., self-defense). In addition, authorizations could be set with the weapon in hand, with the weapon being in a remote location, and/or with the weapon being pre-programmed.

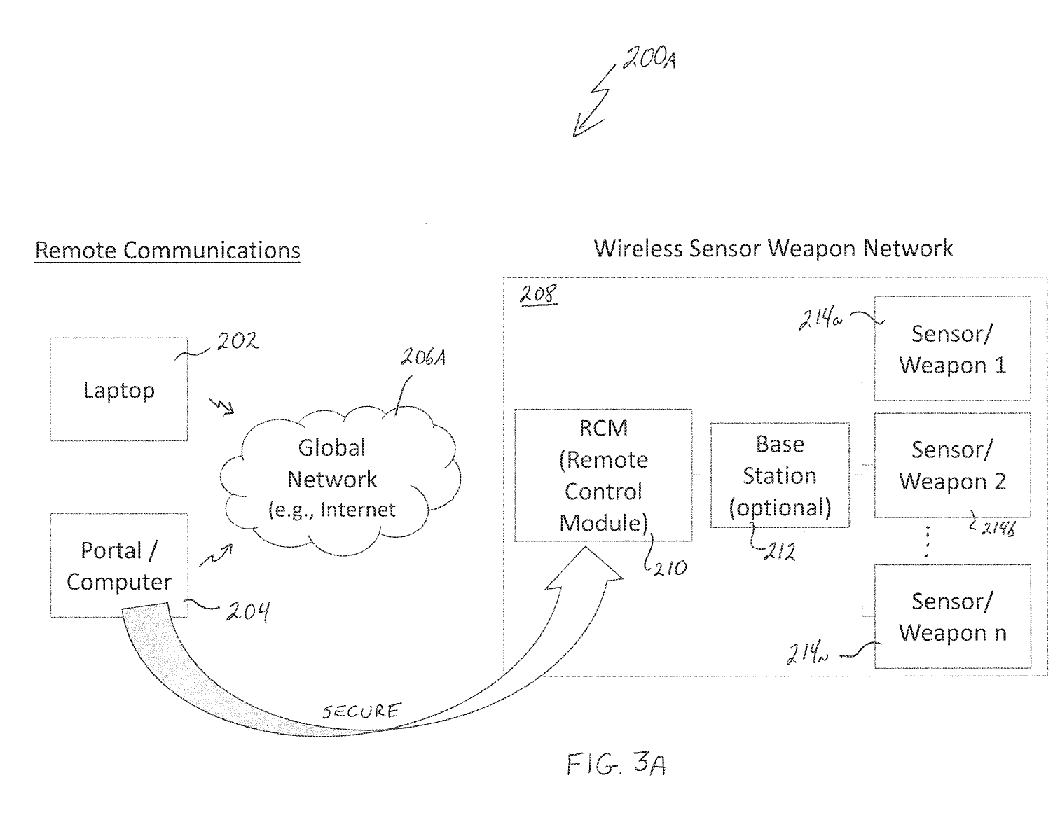

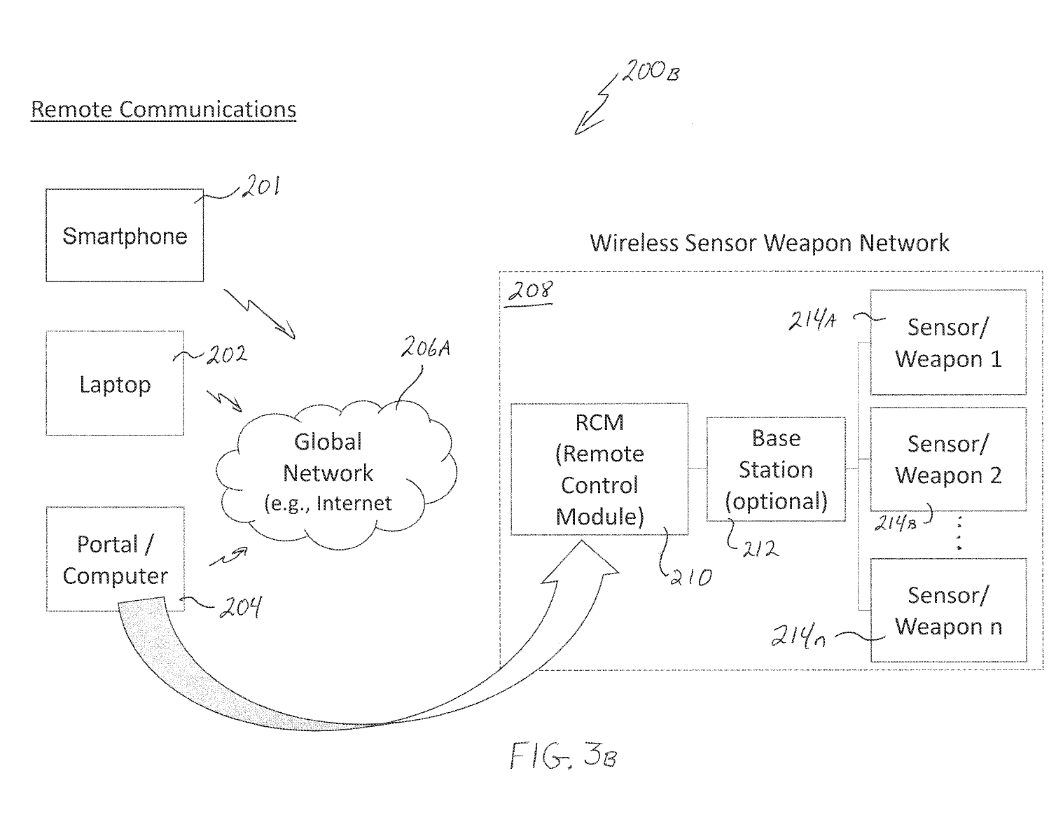

FIG. 3A shows an example of a communication network 200 in accordance with the smart weapon principles disclosed herein. By way of example, wireless sensor weapon network 208 can be established where a remote control module 210 is in communication with a remotely located computer 202 or some dedicated portal computer 204. The computers 202, 204 can be wirelessly connected or have wired connections to a global computer network 206A, such as, for example, the internet. In one implementation, the weapon network includes one or more weapons 214A, 214B, . . . 214n which can be in communication with a base station 212 or in direct communication with the RCM module 210 without the need for base station 212. One important aspect of the present principles is the secure method of communication between the remote communication devices 202,204 and the RCM 208.

On a smaller scale, let's say a private homeowner owns a handgun or rifle with the present smart weapon technology. The handgun or rifle finds its way into the hands of an unauthorized user (e.g., a burglar or even a family member of the registered owner), the owner shall have the ability to remotely deactivate the weapon through the use of their WiFi, or other internet connection. In this example, the authorized user may connect their smartphone 201 (FIG. 3B) wirelessly to the network, or alternatively directly to the weapon using the USB port 116 (see FIG. 2). The smartphone 201 would be equipped with application software that not only can be used to program the authorized users of the weapon, but would allow the user to input any one of the several personal IDs 112 (See FIG. 2), and further allow the user to remotely deactivate or activate the weapon based on their personal ID entered at the smartphone device.

In other implementations, the smartphone 201 is in communication with the weapon 100 (FIG. 2) via the communication systems (e.g., wireless transceiver 114 or USB port 116) such that it can be used as part of the system to authenticate the authorized user of the weapon. For example, the retina sensor, facial recognition, voice recognition, user id/password can all be implemented using an external smartphone device 201.

In other contemplated implementations, the weapon could be configured or programmed only to work when connected to the authorized user's WiFi network in their home. In this implementation, if the weapon is outside the range of the authorized user's WiFi network, the weapon would be deactivated, or disabled. This disabling or deactivation could and should be a default mode for the weapon such that once the weapon is brought within the range of the authorized user's WiFi network, the same location orientation or positioning of the weapon within the authorized range of the WiFi network would operate to prompt the user to input their personal ID in order to “activate” the weapon for operation. Depending on the user's programming configuration, the weapon could be programmed to be “active” whenever within the WiFi range of the authorized user's WiFi network. In this scenario, it is contemplated that the weapon would be active when within the user's residence or business (i.e., active without requiring the user's personal ID) such that the same would be operative for protection in that environment, but once taken outside that environment, and the WiFi connection is lost, the weapon automatically returns to the deactivated or disabled state.

In another contemplated implementation, the weapon can be configured or programmed only to work with the authorized user's voice recognition. In this implementation, the authorized user would speak into the microphone either when prompted or upon initiating use of the weapon. If the voice recognition systems confirm that the speaker is the authorized user, the system will enable the weapon for use.

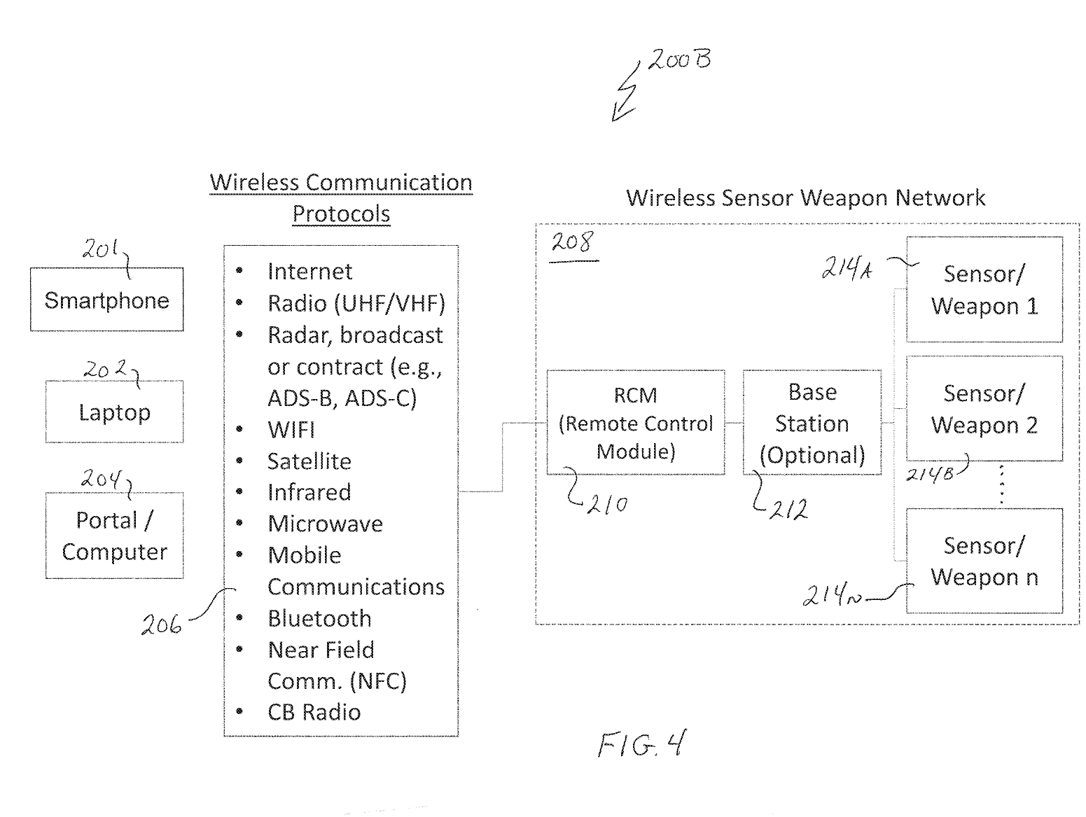

FIG. 4 shows an enhanced smart weapon communication network 200B in accordance with the present principles. As shown, the network connection 206 can be modified according to a desired application and/or range (i.e., distance) of the desired control. The network connection 206 can be, for example, radio (e.g., microwave, cellular/mobile systems, Bluetooth, CB radio), radar (broadcast or contract), WiFi, Satellite or Infrared.

In another exemplary scenario, let's presume a platoon of soldiers having weapons 214 are deployed to a specific geographic area. Through the use of GPS location identification and radio control, the group of weapons 214 can not only be tracked and identified as being within the desired geographic location, but can be remotely activated/deactivated if necessary. For example, in the unfortunate circumstance where the specific geographic area where the platoon was positioned becomes overrun with the enemy, weapons in that geographic area can be deactivated remotely. For example, a tank or multiple tanks in the overrun area can be completely deactivated so that the enemy cannot use the same. The same concepts would hold true for any weapon within the identified geographic region. In addition to the above example of “group protocols” for accessing and controlling weapons, this could be separate from, or in addition to, the authorized user and specific weapon concepts discussed above for the private user as well. In such a situation, the weapons of the individual users within the platoon would be deactivated when the authorized user is stripped from their weapon, either in a hostile situation or as a result of a fatality on the battlefield.

In other GPS implementations, certain geographic zones can be identified as “safe” zones and the weapon would automatically default to a disabled or deactivated state when the weapon is within this geographic zone, regardless of whether it is being handled by the authorized user. A good example of such geographic “safe” zone would be a school zone. Other examples could include sporting events, designated buildings, or any other geographic area that has been identified as an area where no weapons shall be used. As will further be appreciated, this concept of geographic zoning of weapon use is generally directed to the civilian weapon owner, but does have other applications on larger scale law enforcement or military implementations, discussed later.

In another implementation of the present principles, Near Field Communication (NFC) protocols can be implemented into the weapons 214 such that the same are outfitted with NFC tags. The authorized user would have a corresponding NFC communication device that is configured to communicate exclusively with the NFC tag of the weapon and thereby enable the operation of the weapon. Absent the NFC communication device held by the authorized user and being within the range of the weapon, the weapon default would be non-operational. This concept may also be implemented using extended range RFID tags as well. Since the range of NFC is very limited, often times to the body of the one person, this communication protocol could be very well suited for civilian weapon owners. Those of skill in the art will appreciate that NFC technology is primarily an authentication system using RF and possibly other wireless protocols. The concepts behind NFC and how they work are translatable into the smart weapon of the present principles for both authentication of authorized users and/or the deactivation of the weapon when authentication or subsequent communication fails using the NFC protocols.

In all the implementations disclosed herein where a Personal ID is to be entered into the weapon in order to enable the same, it is further contemplated that such authorized use includes a timer system. For example, once the weapon is authorized for use (via any ID mechanism), and the user starts using the weapon, a timer can be configured to determine whether a predetermined amount of time has lapsed since the last use. For example, the authorized user goes to the range and after shooting for a few minutes, stops for more than 60 seconds, for example. In this instance, the weapon would be configured to default back to the disabled state, and the user would be required to prove their authorized user status again. Obviously the time period for non-use for default back to the disabled state can be configured according to manufacturer or user, depending on the particular application for the weapon.

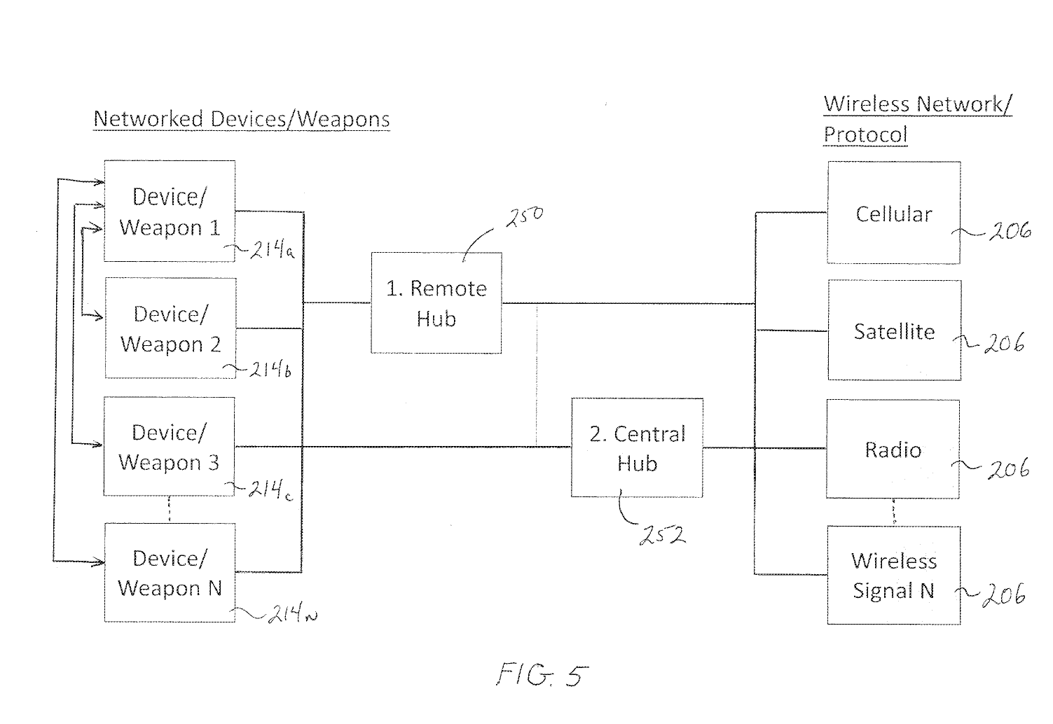

FIG. 5 shows another example of the wireless communication network where the weapons 214 are in communication with either a remote hub 250, a central hub 252, or both, using one of the wireless network protocols 206. By establishing a remote hub 250 or central hub 252, this allows each individual device/weapon 214 to behave more like a “dumb” device for purposes of networking (e.g., simply an individually addressable device). This allows the complexity of networking across multiple wired and/or wireless networks to be handled by more sophisticated remote (250) or central (252) hubs that centralize the networking logic that would otherwise have to be programmed into each weapon into a more powerful hub environment. This would provide advantages such as, for example, determining which network to join for each weapon/device; leveraging bandwidth, security, etc. of networks across devices, and optimizing different wired/wireless networks. Weapons could also connect indirectly to a central or remote hub through weapon to weapon tunneling in an ecosystem of smart weaponry.

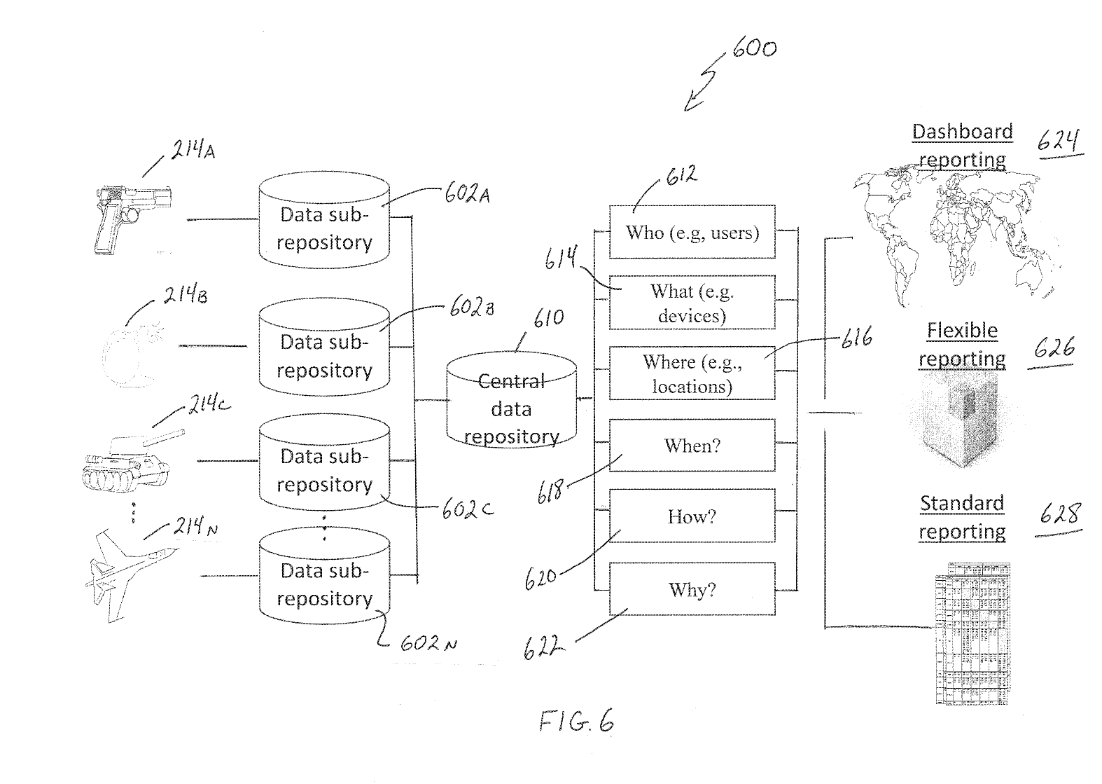

FIG. 6 shows a schematic diagram of a data communication/reporting system 600 in accordance with an implementation of the present principles. Each weapon/device 214A-214n is in communication with a data sub-repository 602A-602n, respectively. Thus, in this implementation, the data-sub repository 602 can correspond to a specific grouping of weapons/devices 214 or groups of weapons/devices depending on the desired implementation. Each data sub-repository 602 is connected to a central data repository 610 which can be configured to store and/or sort the data in many different ways. For example, the data can be sorted based on who (e.g., the specific users) 612, what (e.g., the devices/weapons) 614 in desired grouping or listing of the same, where (e.g., what is the physical location of the device/weapon) 616, when (e.g., when was the device/weapon detonated 618, how (e.g., with device in hand or remote) 620, and why (the weapon was detonated/permanently disabled) 622. By categorizing the data as proposed, the ability to report the same can be performed as desired. For example, a dashboard like reporting 624 can be provided where a map is displayed and the various devices/weapons as deployed are shown on the map in some graphical manner (e.g., different colors). The ability to provide flexible reporting 626 allows the user to access the central data repository 610 to customize their report. For example, the user may want to see where all the firearms 214A are located at the moment (either in air or on ground), in addition to where the tanks 214C are located on the ground, but is not interested in the grenades 2148 or firearms 214A. The flexible reporting 626 allows for this level of customization. Standard reporting 628 can simply output lists of the devices/weapons and provide the who, what, where, when, how, and why for all of the same. The “who” 612, can be, for example, the names or identification of a specific military unit, the personal identification data (e.g., biometrics, retina scans, user id), device authorizations, geographic authorizations, etc. The “what” 614, can be, for example, the category of devices (e.g., military, police, civilian consumer), the type of device (e.g., weapon, ammunition, vehicle, aircraft, firearm), the authorized users for such device, the authorized locations within which the device may be used, network authorizations, etc. The “where” 616, can be, for example, the geographic locations, the authorized users within the geographic areas, the authorized devices within the particular geographic location. The “when” 618, can be, for example, the date and time that the weapon was detonated. The “how” 620, can be, for example, the method used to detonate the weapon (e.g., while in hand or remote). The “why” 622, can be, for example, the reason the weapon was detonated (which could be captured by the microphone (FIG. 2 126).

The system shown in FIG. 6 may also be configured to allow for real time monitoring of the weapons and ammunition. In this case, the need for data repositories and the reviewing of the same would be eliminated, and graphic displays can be provided that are either color coded or otherwise designated for easy reference/review. It will be further appreciated that the weapons/devices will include their own memory systems (e.g., for personal ID storage), however these memory systems can also be integrated and configured to store the activity of the weapon/device, including, but not limited to the use of the weapon/device, the location of the same, etc. By allowing the weapon/device to record its activity, the same can be accessed at a later time (either wirelessly or through a wired connection) for download or simply to review. Such memory could be considered a “black box” of the weapon, similar to that concept as used in airplanes.

In accordance with other contemplated implementations, the smart weapon 100 of the present principles may be designed/programmed with certain default settings that cannot be changed once set. Another version of default settings can be, as mentioned above, geographic limitations of the use of the weapon. Once the weapon passes into a non-approved or unauthorized geographic region, the weapon's systems detect such position and disable/deactivate the operation of the weapon.

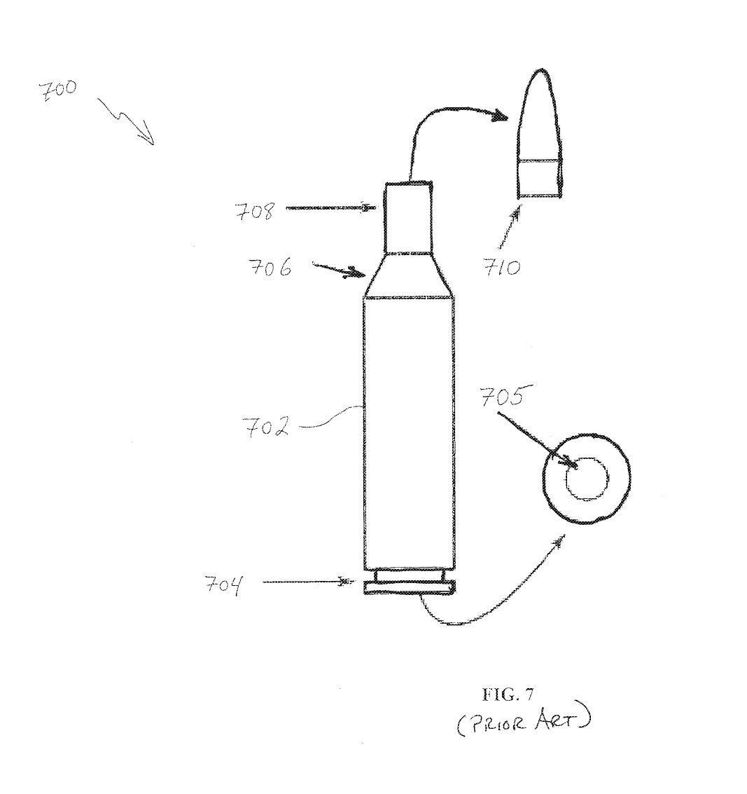

FIG. 7 shows the anatomy of a “dumb” bullet or standard firearm ammunition 700 according to known art. As will be appreciated, a standard bullet includes a casing 702, with a rim 704 at the base thereof. A primer pocket 705 is substantially centrally located on the bottom of the rim 704. The upper end of the casing 702 generally includes a shoulder 706, and sometimes includes a neck 708, but neither the shoulder 706 nor neck 708 are required depending on the bullet configuration. The projectile or bullet 710 is secured in place within the casing 702 during manufacturing of the same.

As those of skill in the art will appreciate, the casing 702 is generally filled with gun powder, and at the base by the rim 704, the primer pocket 705 is what is struck by the hammer of the weapon to ignite the gun powder and create the explosion within the casing that sends the projectile or bullet 710 down the barrel of the weapon.

FIG. 8A shows an example of a bullet or ammunition 800A according to an implementation of the present principles. The casing 802 can include the shoulder 806 and neck 808 (although those of skill in the art will appreciate that these features are not always necessary depending on the particular ammunition). The rim 804 with primer pocket 805 is also positioned as would be expected. Internally, the smart ammunition 800 includes a processor 820, a memory 822, communication circuitry 824 and an activation/deactivation system 826. The activation/deactivation system 826 is positioned between the primer pocket 805 and the gun powder 815. The activation/deactivation system 826 is configured such that it can allow or disallow communication between the primer pocket 805 and the gun powder 815. This can be done in many ways, such as, for example, an electronic switch or solenoid, an electronic relay or the like.

In accordance with one implementation, the communication circuitry 826 is in communication with an authorized user (e.g., by way of radio frequency) such that smart bullet 800 knows that the authorized user is within a predetermined proximity of the smart bullet and maintains the same as active. In this implementation, NFC radio technology would be best suited to enable the communication between the authorized user and the smart ammunition within the firearm they are using.

In one NFC implementation, the user's firearm could have a DNA sampling system whereby the NFC device on the user has the ability to sample the user's DNA (e.g., by blood, skin, hair) and only in the event that the user's DNA matches that stored in the NFC device positioned on the user, would the NFC Device communicate with the smart bullet/ammunition 800 via communication circuitry 826 to maintain an active state of the same. As will be appreciated, should the authorized user lose their weapon to an enemy, the bullet/ammunition 800 will default to a de-activated state and the enemy would be unable to user the same.

In accordance with another implementation, the communication circuitry 826 can be in communication with the weapon for which it is intended to be used. For example, referring to FIGS. 2 and 8A, the transceiver 114 of the weapon/device will be in communication with the communication circuitry 824 of the ammunition associated with the weapon. The ammunition 800A would have a personal ID or more specifically, a “weapon” ID that is configured specifically for the “authorized” weapon/device within which it can be used. In this manner, should someone attempt to use the ammunition 800A in a weapon for which it is not specifically made (and authorized for), it will not work and will default to a deactivated state. The same holds true for the weapon 100. The weapon 100 can be configured to look for a weapon ID on the ammunition being used for the same, and in the event there is no match, the weapon 100 can be deactivated so as to be unable to fire the unauthorized ammunition.

In accordance with another implementation, the communication circuitry 826 can be in communication with a central station or other remote monitoring station. In this manner, the central station or remote monitoring station would have the ability to remotely activate/deactivate the smart bullet/ammunition 800A.

The communication circuitry 824 may include, inter alia, RF (Radio Frequency), Bluetooth, and/or WiFi capable communications. As such, and as discussed above with respect to the weapon communication any desired communication protocol can be used depending on the desired application. In a weapon to ammunition or ammunition to weapon communication scenario as described above, and RF protocol seems appropriate. The WiFi concept can also be implemented where both the weapon and the ammunition must be within range of the WiFi network on which it is registered in order for the same to work. So, one could envision a scenario where the weapon/device 100 is stolen from the registered owner. In this instance, even if the thief takes the ammunition with the weapon from the registered owner, the same would not work outside the WiFi range.

Alternatively, in another implementation, the registered weapon owner configures their weapon and/or their ammunition to communicate with an application running on their smartphone. In this scenario, the registered owner would have the ability to know the weapon/ammunition have been removed (stolen) from its storage location (e.g., through the application of the GPS technology), and then the user (and law enforcement personnel) can not only track the location of the stolen weapon or ammunition, but can assure that neither can be used by the unauthorized individual now in possession of the same.

FIG. 8B shows another implementation of the ammunition 800B according to the present principles. In this implementation, the ammunition 800B includes geographic positioning system circuitry 828. With the inclusion of such GPS systems, the above-mentioned controls over the weapon/device 100 relating to the ability to activate or deactivate the same based on its geographic location can also be implemented.

In accordance with one implementation of the present principles, the weapons/devices will have “active” enablement/disablement features. This allows the weapon/device to be enabled, disabled, monitored and/or controlled remotely using the weapons/device's personal identifiers 112 or override capabilities as previously programmed. In this scenario, it will be apparent that an unauthorized user of the weapon/device whose personal identifier is not already programmed into the weapon/device will not be able to use the same. In this mode, the ability to remotely reprogram the weapon/device would preferably not be possible, may only be possible by an administrator of the system having very high security clearance, not to mention very high encryption for such communication, and/or by a user that has already been granted access to the weapon and/or ammunition

In accordance with another implementation the weapons/devices will have “passive” enablement/disablement features. In this mode, the weapon/device may be enabled or disabled when in physical possession (e.g., by modifying or re-programming personal identifiers). The ability to reprogram the weapon/device would also require an administrator with very high security clearance and high encryption.

In accordance with yet another implementation, the weapons/device will have “automatic” enablement/disablement features. In this mode, the weapon/device can be programed or preprogrammed to be enabled/disabled upon a triggering event (e.g., date, time, event, geographic location, etc.). In this mode, the event could be anything . . . for example, it could be a time out and the device/weapon is disabled after 30 days or some other present time period or date. For example, a time out system can be employed whereby upon issuance of the weapon, the processor starts an internal timer. During the countdown of the timer, the weapon is active and can be used. Upon the expiration of the time, the weapon is automatically disabled. This concept could have applications in a recreational setting (e.g., paint ball guns, nerf guns) where users pay for certain period of time, and once the time expires, so do the weapons being used for the same.

In another example, the trigger event could be the presence of the weapon within a designated geographic no-weapon area, such as, for example, a school, a wildlife preserve, etc. In this scenario, the school, wildlife preserve or other very specific designated or “protected” geographic area could broadcast wireless signals configured to identify the presence of such smart weapons, and not only provide a notification as to the presence of such weapons, but can confirm that the same are deactivated remotely by such system. Alternatively, the “protected” geographic areas would be programmed into the maps used by the GPS systems so the weapon automatically knows where these restricted areas are. This system can and would be used to override an authorized user/owner of the weapon and/or ammunition entering the protected geographic area.

Another implementation contemplates the “future state” of the weapon/ammunition. For example, imagine a weapon/device gets into the wrong hands. The “central control facility” would have more options beyond just deactivating the weapon.

Another example, imagine drones with weapon facilities, previously places weapons and/or ammunition, or tanks that were confiscated by the enemy, that can be controlled from a central control station.

According to another implementation of smart weapons, the ability to contemplate and prevent a suicide attempt is also disclosed herein. FIGS. 9A and 9B show an example of a weapon 900 in accordance with such principles. Weapon 900 includes a handle portion 902 having a front portion 912 and a rear portion 910, a barrel portion 904, a trigger 906 and a trigger guard 908. FIG. 9B shows a crude schematic block diagram of partial cross section of the weapon 900 having a plurality of accelerometers 920, 922 positioned within the barrel 904 and another plurality of accelerometers 924, 926 positioned within the handle portion 902. A processor with associated memory and some communication circuitry 930 is also integrated into the weapon 900 in any suitable location within the same.

By integrating a series of accelerometers into the weapon, in various locations, the physical position and orientation of the weapon (and more specifically, the barrel) as it relates to the holder and handle of the same can be determined. Furthermore, by adding pressure sensors 932 and 934 into the front portion 912 and rear portion 910, respectively of the grip 902, the hand pressure on the same can be measured and monitored. Thus, the weapon 900 is equipped with the processing technology described above with respect to FIG. 2 and as shown with block 930, the programming of the weapon for the authorized user can include pressure/position measurements. When the weapon is programmed for the authorized user, the accelerometers can be used to measure, track, and monitor the movement of the weapon, as being handled by the authorized user, and in the event either the accelerometers and/or the pressure sensors identify a use that is not in accordance with the authorized use or authorized user's programming (e.g., the pressure on the handle 902 is below that required for the authorized user to be holding the weapon), the weapon can be deactivated automatically.

The above concept can be used, for example, to sense when the authorized user is attempting to commit suicide by pointing the gun toward themselves, and automatically deactivate the weapon before the trigger can be pulled.

The above description and implementations of the present principles have been made by referring to conventional mechanical weapons that generally use ammunition associated with the same. However, as will be appreciated electronic guns and electronic bullets are also considered within the scope of the present principles, and in fact such principles may even be easier to implement in such systems already having appropriate electronics and control systems. For example, in an electronic gun, the need for mechanical trigger is eliminated, and an electronic button is used to fire the same. It will become readily apparent to those of skill in the art of weapons and electronics that the ability to disable a weapon having an electronic button, compared to a mechanical trigger can be implemented easily.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles are not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

What is claimed is:

1. A round of ammunition comprising:
a casing, a projectile, gun powder, a firing mechanism; and
a controller integrated into the round, the controller including a deactivation system configured to prevent the firing mechanism from firing the round responsive to a command.

2. The round according to claim 1, wherein the controller includes a communication system in communication with a personal ID system configured to identify an authorized user of the round.

3. The round according to claim 2, wherein the round is deactivated when in the possession of an unauthorized user.

4. The round according to claim 2, wherein a camera system is integrated into the personal ID system and enables the use of facial recognition techniques to identify the authorized user.

5. The round according to claim 2, wherein the personal ID system is programmed upon purchase or issuance of the personal ID system, said programming including at least one of the following personal ID technologies:
user ID and password;
retinal scan;
facial recognition;
voice recognition; and
DNA sampling of the authorized user.

6. The round according to claim 2, wherein the personal ID system comprises a near field communication (NFC) protocol and the authorized user is issued a corresponding NFC device, wherein the round can only be fired when the authorized user's NFC device is within a predetermined distance from the same.

7. The round according to claim 2, wherein the personal ID system includes a microphone and a speaker, said microphone being configured to receive voice commands from the authorized user using voice recognition.

8. The round according to claim 2, wherein the personal ID system includes a USB connection port, said USB connection port being configured to receive a connection from a computing device to enable programming and reprogramming of authorized user personal ID information.

9. The round according to claim 1, wherein the controller includes a near field communication (NFC) protocol and an authorized user is issued a corresponding NFC device, wherein the round is deactivated while the authorized user's NFC device is outside a predetermined distance from the same.

10. The round according to claim 1, wherein the controller includes a geographic positioning system (GPS) and the round is deactivated when the round is outside a predetermined geographic location.

11. The round according to claim 10, wherein the round is reactivated when returned to the predetermined geographic location.

12. The round according to claim 1, wherein the controller is linked to a weapons identification (ID) and will deactivate the round if attempted to be fired from another weapon.

13. A round of ammunition comprising:
a casing, a projectile, gun powder, a firing mechanism; and
a controller integrated into the round, the controller including an activation system configured to permit the firing mechanism to fire the round responsive to a command.

14. The round according to claim 13, wherein the controller includes a communication system in communication with a personal ID system configured to identify an authorized user of the round.

15. The round according to claim 14, wherein the round is activated when in the possession of the authorized user.

16. The round according to claim 14, wherein the personal ID system comprises a near field communication (NFC) protocol and the authorized user is issued a corresponding NFC device, wherein the round can only be fired when the authorized user's NFC device is within a predetermined distance from the same.

17. The round according to claim 13, wherein the controller includes a near field communication (NFC) protocol and an authorized user is issued a corresponding NFC device, wherein the round is only activated while the authorized user's NFC device is within a predetermined distance from the same.

18. The round according to claim 13, wherein the controller includes a geographic positioning system (GPS) and the round is only activated when the round is located inside a predetermined geographic location.

19. The round according to claim 18, wherein the round is deactivated when the round is removed from the predetermined geographic location.

20. The round according to claim 13, wherein the controller is linked to a weapons identification (ID) and will only activate the round if attempted to be fired from a weapon with the weapons ID.
